(19) United States
(12) Patent Application Publication
(10) Pub. No.: US 2025/0289723 A1
(43) Pub. Date: Sep. 18, 2025

(54) SYNTHESIS OF ZEOLITIC MATERIALS OF THE IWR FRAMEWORK STRUCTURE TYPE FROM ZEOLITIC PRECURSOR MATERIALS

(71) Applicant: BASF SE, Ludwigshafen am Rhein (DE)

(72) Inventors: Trees Maria DE BAERDEMAEKER, Ludwigshafen am Rhein (DE); Andrei-Nicolae PARVULESCU, Ludwigshafen am Rhein (DE); Feng-Shou XIAO, Hangzhou (CN); Xiangju MENG, Hangzhou (CN); Weiping ZHANG, Dalian City (CN); Jaroslaw Michael MORMUL, Ludwigshafen am Rhein (DE); Joaquim Henrique TELES, Ludwigshafen am Rhein (DE)

(21) Appl. No.: 18/862,689

(22) PCT Filed: May 4, 2023
(86) PCT No.: PCT/EP2023/061785

§ 371 Date: Nov. 4, 2024

(30) Foreign Application Priority Data
May 5, 2022 (WO) PCT/CN2022/090915

(51) Int. Cl. C01B 39/48

(52) U.S. Cl. CPC C01B 39/48; C01P 2002/72; C01P 2004/03

(57) ABSTRACT

The present invention relates to a process for the preparation or a zeolitic material having an IWR framework structure, as well as to a zeolitic material having an IWR framework structure obtained and/or obtainable by said process, and to the use of said zeolitic material.

### TECHNICAL FIELD

The present invention relates to a process for the preparation or a zeolitic material having an IWR framework structure, as well as to a zeolitic material having an IWR framework structure obtained and/or obtainable by said process, and to the use of said zeolitic material.

### INTRODUCTION

The ITQ-24 zeolite with IWR structure was first synthesized in the presence of germanium species using hexamethonium as an organic template. Thus, EP 1 609 758 B1 discloses the zeolite Ge-ITQ-24 which is obtained with Ge as a tetravalent element in addition to Si in its zeolitic framework.

Because of its unique three dimensional 12×10×10-membered ring pore structure (aperture size of 5.8×6.8, 4.6×5.3, and 4.6×5.3 Å), ITQ-24 has attracted much attention. However, when a large amount of germanium species exist in the IWR framework, its thermal and hydrothermal stability is remarkably reduced. In addition, the use of germanium species in the synthesis is costly, which strongly hinders the applications of IWR zeolite as heterogeneous catalysts. To solve this problem, Cantin, A. et al. in J. Am. Chem. Soc. 2006, 128, pp. 4216-4217 describe a Ge-free route for the synthesis of IWR zeolite by introduction of boron species instead of germanium due to very close Si—O—Ge angles to those of Si—O—B, wherein with the assistance of seeds, pure silica IWR could also be synthesized. However, from the view of industrial applications, the aluminosilicate IWR zeolite would be more attractive due to its strong acidity and superior thermal and hydrothermal stabilities. Due to the lack of a direct synthesis of aluminosilicate IWR zeolite, Shamzhy, M. et al. in Catal. Today 2015, 243, 76-84 describe a post-synthesis treatment for alumination of borogermanosilicate IWR zeolite.

WO 2020/244630 A, on the other hand, discloses a direct synthesis of an aluminosicate having the IWR framework structure, wherein the obtained material is free of germanium. As may be taken from Hong, X. et al. in J. Am. Chem. Soc. 2019, 141, 45, 18318-18324, said material is denoted as COE-6.

In view of the progress made relative to the synthesis of zeolitic materials having the IWR framework structure, methods were developed for obtaining zeolitic materials containing further heteroatoms in their framework structure. Thus, CN 111847474 A concerns the synthesis of Ti-ITQ-24, wherein the framework contains exclusively Si and Ti as the tetravalent elements in its structure. A synthesis of Ti-ITQ-24 is also described in U.S. Pat. No. 7,344,696 B2, wherein B-Ti-ITQ-24 is synthesized in a first step, and the boron subsequently leached out of the material via acidic deboronation.

Despite said results, there is an ongoing the need for synthetic procedures affording zeolitic materials displaying improved physical and chemical properties, in particular in view of their frequent use in catalytic applications.

### DETAILED DESCRIPTION

It was therefore the object of the present invention to provide improved zeolitic materials having an IWR type framework structure and methods for their synthesis. Furthermore, it was the object of the present invention to provide an improved zeolitic material for catalytic applications, in particular for heterogeneous catalysis, and particularly as a catalyst in epoxidation reactions. Thus, it has surprisingly been found that a zeolitic material having an IWR type framework structure comprising Si and a further tetravalent element in its framework may be synthesized in particularly high purity and high crystallinity.

Therefore, the present invention relates to a process for the preparation of a zeolitic material having an IWR type framework structure, wherein the process comprises
(1) preparing a mixture comprising one or more organotemplates as structure directing agents, one or more zeolitic materials comprising SiO₂ and YO₂ in its framework structure, wherein Y is a tetravalent element other than Si, one or more sources of SiO₂ other than the one or more zeolitic materials, and a solvent system;
(2) heating the mixture obtained in (1) for crystallizing a zeolitic material having an IWR type framework structure comprising SiO₂ and YO₂ in its framework structure;
wherein the one or more organotemplates comprise an organodication of the formula (I):

R³R⁵R⁶N⁺—R¹-Q-R²—N⁺R⁴R⁷R⁸ (I);
wherein R¹ and R₂ independently from one another stand for (C₁-C₃)alkylene, preferably for C₁ or C₂ alkylene, more preferably for methylene or ethylene, and more preferably for methylene;
wherein Q stands for C₆-arylene, preferably for 1,4-C₆-arylene, and more preferably for benzene-1,4-diyl;
wherein R³ and R₄ independently from one another stand for (C₁-C₄)alkyl, preferably (C₁-C₃)alkyl, more preferably for methyl or ethyl, and more preferably for methyl; and
wherein R₅, R₆, R₇, and R₈ independently from one another stand for (C₁-C₆)alkyl, preferably (C₁-C₅)alkyl, more preferably (C₁-C₄)alkyl, more preferably (C₁-C₃)alkyl, more preferably for ethyl, isopropyl, or n-propyl, and more preferably for ethyl or n-propyl.

It is preferred that the one or more zeolitic materials in (1) display a framework structure type selected from the group consisting of MFI, MWW, MEL, BEA, CHA, MOR, and mixtures of two or more thereof, more preferably from the group consisting of MFI, MWW, BEA, and mixtures of two or more thereof, wherein more preferably the one or more zeolitic materials in (1) display an MFI and/or MWW type framework structure.

It is preferred that the tetravalent element Y is selected from the group consisting of Sn, Ti, Zr, and mixtures of two or more thereof, Y more preferably being Sn and/or Ti, wherein Y is more preferably Ti. According to particular and preferred embodiments wherein Y is Ti, it is preferred that the one or more zeolitic materials in (1) comprising SiO₂ and YO₂ in its framework structure comprises ZMQ-TB and/or TS-1, more preferably TS-1, wherein preferably the one or more zeolitic materials comprising SiO₂ and YO₂ in its framework structure is ZMQ-TB and/or TS-1, preferably TS-1. Furthermore and independently thereof, according to particular and preferred embodiments wherein Y is Ti, it is preferred that the zeolitic material in (2) having an IWR type framework structure is Ti-COE-6.

It is preferred that the one or more sources of SiO₂ other than the one or more zeolitic materials is selected from the group consisting of silicates, fumed silica, silica hydrosols, reactive amorphous solid silicas, silica gel, silicic acid, colloidal silica, silicic acid esters, and mixtures of two or more thereof,
more preferably from the group consisting of silica hydrosols, silica gel, silicic acid, water glass, sodium metasilicate hydrate, sesquisilicate, disilicate, colloidal silica, tetra(C₁-C₄)alkylorthosilicate, and mixtures of two or more thereof,
more preferably from the group consisting of silica hydrosols, silicic acid, tetra(C₂-C₃)alkylorthosilicate, and mixtures of two or more thereof,
wherein more preferably the one or more sources for SiO₂ comprises tetraethylorthosilicate, wherein more preferably tetraethylorthosilicate is used as the one or more sources for SiO₂.

It is preferred that the alkyl groups R₅ and R₆ are bound to one another to form one common alkylene chain, more preferably a (C₅-C₇)alkylene chain, more preferably a (C₅-C₆)alkylene chain, more preferably a pentylene or hexylene chain, and more preferably a pentylene chain.

It is preferred that the alkyl groups R₇ and R⁸ are bound to one another to form one common alkylene chain, more preferably a (C₅-C₇)alkylene chain, more preferably a (C₅-C₆)alkylene chain, more preferably a pentylene or hexylene chain, and more preferably a pentylene chain.

It is preferred that the organodication of the formula (I) has the formula (II):

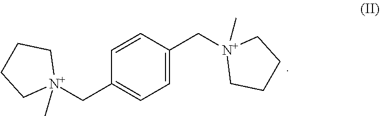 [SMILES: C[N+]1(Cc2ccc(C[N+]3(C)CCCC3)cc2)CCCC1]

It is preferred that the one or more organotemplates are provided as salts, more preferably as one or more salts selected from the group consisting of halides, sulfate, nitrate, phosphate, acetate, hydroxide, and mixtures of two or more thereof, more preferably from the group consisting of bromide, chloride, hydroxide, sulfate, and mixtures of two or more thereof, wherein more preferably the one or more organotemplates are provided as hydroxides and/or bromides, and more preferably as hydroxides.

It is preferred that the mixture prepared in (1) further comprises seed crystals, wherein the seed crystals preferably comprise one or more zeolitic materials having an IWR type framework structure, more preferably one or more all-silica zeolitic materials having an IWR type framework structure, wherein more preferably the seed crystals comprise all-silica ITQ-24, wherein more preferably one or more zeolitic materials having an IWR type framework structure is employed as the seed crystals, more preferably one or more all-silica zeolitic materials having an IWR type framework structure, wherein more preferably all-silica ITQ-24 is employed as the seed crystals.

In case where the mixture prepared in (1) further comprises seed crystals, it is preferred that the amount of seed crystals comprised in the mixture prepared in (1) is in the range of from 0.1 to 25 wt.-% based on 100 wt.-% of the one or more sources of SiO₂ other than the one or more zeolitic materials calculated as SiO₂, and more preferably from 0.5 to 20 wt.-%, more preferably from 1 to 18 wt.-%, more preferably from 3 to 15 wt.-%, more preferably from 5 to 12 wt.-%, and more preferably from 8 to 9 wt.-%.

It is preferred that the mixture prepared in (1) and heated in (2) contains less than 5 weight-% of Ge calculated as GeO₂ and based on 100 weight-% of the one or more sources of SiO₂ other than the one or more zeolitic materials calculated as SiO₂, more preferably less than 3 weight-%, more preferably less than 1 weight-%, more preferably less than 0.5 weight-%, more preferably less than 0.1 weight-%, more preferably less than 0.05 weight-%, more preferably less than 0.01 weight-%, more preferably less than 0.005 weight-%, and more preferably less than 0.001 weight-%.

It is preferred that the mixture prepared in (1) and heated in (2) contains less than 0.5 weight-% of trivalent elements X calculated as the element and based on 100 weight-% of Si contained in the mixture, more preferably less than 0.1 weight-%, more preferably less than 0.05 weight-%, more preferably less than 0.01 weight-%, more preferably less than 0.005 weight-%, and more preferably less than 0.001 weight-%. It is preferred that X is Al and/or B, wherein more preferably X is Al and B, wherein more preferably X is Al, B, and Ga, and wherein more preferably X is Al, B, In, and Ga.

It is preferred that the mixture prepared in (1) and heated in (2) contains less than 5 wt.-% of P based on 100 wt.-% of Si contained in the mixture, more preferably less than 3 weight-%, more preferably less than 1 weight-%, more preferably less than 0.5 weight-%, more preferably less than 0.1 weight-%, more preferably less than 0.05 weight-%, more preferably less than 0.01 weight-%, more preferably less than 0.005 weight-%, and more preferably less than 0.001 weight-%.

It is preferred that the one or more zeolitic materials comprising SiO₂ and YO₂ contained in the mixture prepared in (1) and heated in (2) displays an Si:Y atomic ratio Si to the tetravalent element Y in the range of from 5:1 to 500:1, more preferably of from 10:1 to 250:1, more preferably of from 20:1 to 150:1, more preferably of from 25:1 to 100:1, more preferably of from 30:1 to 70:1, more preferably of from 32:1 to 50:1, more preferably of from 34:1 to 42:1, and more preferably of from 36:1 to 39:1.

It is preferred that the Si:Y atomic ratio of Si to the tetravalent element Y in the mixture prepared in (1) and heated in (2) is in the range of from 5 to 1,500, more preferably of from 10 to 1,000, more preferably of from 20 to 600, more preferably of from 30 to 400, more preferably of from 40 to 250, more preferably of from 50 to 150, more preferably of from 60 to 100, and more preferably of from 70 to 80.

It is preferred that the organotemplate:Si molar ratio of the one or more organotemplates to Si in the mixture prepared in (1) and heated in (2) is in the range of from 0.01 to 1.5, more preferably from 0.05 to 1.2, more preferably from 0.1 to 0.9, more preferably from 0.15 to 0.7, more preferably from 0.2 to 0.5, and more preferably from 0.25 to 0.3.

It is preferred that the mixture prepared in (1) further comprises one or more sources of fluoride, wherein more preferably the F:Si atomic ratio in the mixture prepared in (1) and heated in (2) is in the range of from 0.01 to 2, preferably from 0.05 to 1.5, more preferably from 0.1 to 1, more preferably from 0.3 to 0.8, and more preferably from 0.5 to 0.6. It is preferred that the one or more sources of fluoride is selected from fluoride salts, HF, and mixtures of two or more thereof, more preferably from the group consisting of alkali metal fluoride salts, HF, and mixtures of two or more thereof, wherein more preferably the one or more sources of fluoride comprise HF, wherein more preferably HF is employed as the one or more sources of fluoride.

It is preferred that heating in (2) is conducted for a duration in the range of from 10 min to 10 d, more preferably from 30 min to 9 d, more preferably from 1 h to 8 d, more preferably from 2 h to 7 d, and more preferably from 3 h to 6 d, more preferably from 6 h to 5.5 d, more preferably from 0.5 to 5 d, more preferably from 1 d to 4.5 d, more preferably from 2 d to 4 d, and more preferably from 2.5 to 3.5 d.

It is preferred that heating in (2) is conducted at a temperature in the range of from 80 to 220° C., more preferably of from 110 to 200° C., more preferably of from 130 to 190° C., more preferably of from 140 to 180° C., more preferably of from 150 to 170° C., and more preferably of from 155 to 165° C.

It is preferred that heating in (2) is conducted under autogenous pressure, more preferably under solvothermal conditions, more preferably under hydrothermal conditions, wherein preferably heating in (2) is performed in a pressure tight vessel, preferably in an autoclave.

It is preferred that the process further comprises
(3) isolating the zeolitic material obtained in (2),
and/or
(4) washing the zeolitic material obtained in (2) or (3),
and/or
(5) calcining the zeolitic material obtained in (2), (3), or (4),
wherein the steps (3) and/or (4) and/or (5) can be conducted in any order, and
wherein one or more of said steps is preferably repeated one or more times.

It is preferred that calcination in (5) is conducted for a duration in the range of from 0.5 to 15 h, more preferably of from 1 to 10 h, more preferably of from 2 to 8 h, more preferably of from 3 to 7 h, more preferably of from 3.5 to 6.5 h, more preferably of from 4 to 6 h, and more preferably of from 4.5 to 5.5 h. Furthermore and independently thereof, it is preferred that calcination in (5) is conducted at a temperature in the range of from 300 to 800° C., more preferably of from 350 to 700° C., more preferably of from 400 to 650° C., more preferably of from 450 to 600° C., and more preferably of from 500 to 550° C.

It is preferred that the solvent system is selected from the group consisting of optionally branched (C₁-C₄) alcohols, distilled water, and mixtures thereof, more preferably from the group consisting of optionally branched (C₁-C₃) alcohols, distilled water, and mixtures thereof, more preferably from the group consisting of methanol, ethanol, distilled water, and mixtures thereof, wherein more preferably the solvent system comprises distilled water, wherein more preferably the solvent system consists of distilled water. According to particular and preferred embodiments wherein the solvent system comprises or consists of distilled water, it is preferred that the H₂O:YO₂ molar ratio of H₂O to the one or more sources of SiO₂ other than the one or more zeolitic materials, calculated as SiO₂, in the mixture prepared in (1) and heated in (2) is in the range of from 0.5 to 15, more preferably from 1 to 10, more preferably from 1.5 to 5, and more preferably from 2 to 3.

The present invention also relates to a zeolitic material having an IWR type framework structure obtainable and/or obtained from the process of any one of the particular and preferred embodiments of the present invention.

It is preferred that the zeolitic material having an IWR type framework structure is Ti-COE-6.

The present invention also relates to the use of the zeolitic material having an IWR type framework structure according to any one of the particular and preferred embodiments of the present invention as a molecular sieve, as an adsorbent, for ion-exchange, or as a catalyst and/or as a catalyst support, wherein the zeolitic material is more preferably used as a catalyst in a reaction involving C—C bond formation and/or conversion, and preferably as a catalyst in an isomerization reaction, in an amoximation reaction, in an amination reaction, in a hydrocracking reaction, in an alkylation reaction, in an acylation reaction, in a reaction for the conversion of alkanes to olefins, or in a reaction for the conversion of one or more oxygenates to olefins and/or aromatics, in a reaction for the synthesis of hydrogen peroxide, in an aldol condensation reaction, in a reaction for the isomerization of epoxides, in a transesterification reaction, in a hydroxylation reaction, in a Baeyer-Villiger-type oxidation reaction, in a Dakin-type reaction, in the synthesis of isoprenol, in a Prins condensation reaction, or in an epoxidation reaction, preferably as a catalyst in a hydroxylation reaction, in a Baeyer-Villiger-type oxidation reaction, in a Dakin-type reaction, in a Prins condensation reaction, or in a reaction for the epoxidation of olefins, more preferably in a reaction for the epoxidation of olefins, more preferably in a reaction for the epoxidation of C2-C5 alkenes, more preferably in a reaction for the epoxidation of C2-C4 alkenes, in a reaction for the epoxidation of C2 or C3 alkenes, more preferably for the epoxidation of C3 alkenes, and more preferably as a catalyst for the conversion of propylene to propylene oxide.

It is preferred that the zeolitic material is used as a catalyst for the activation of hydrogen peroxide.

The present invention is further illustrated by the following set of embodiments and combinations of embodiments resulting from the dependencies and back-references as indicated. In particular, it is noted that in each instance where a range of embodiments is mentioned, for example in the context of a term such as “The . . . of any one of embodiments 1 to 4”, every embodiment in this range is meant to be explicitly disclosed for the skilled person, i.e. the wording of this term is to be understood by the skilled person as being synonymous to “The . . . of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A process for the preparation of a zeolitic material having an IWR type framework structure, wherein the process comprises
   (1) preparing a mixture comprising one or more organotemplates as structure directing agents, one or more zeolitic materials comprising SiO₂ and YO₂ in its framework structure, wherein Y is a tetravalent element other than Si, one or more sources of SiO₂ other than the one or more zeolitic materials, and a solvent system;
   (2) heating the mixture obtained in (1) for crystallizing a zeolitic material having an IWR type framework structure comprising SiO₂ and YO₂ in its framework structure;
   wherein the one or more organotemplates comprise an organodication of the formula (I):

R₃R₅R₆N⁺—R₁-Q-R₂—N⁺R₄R₇R₈ (I);
wherein R¹ and R₂ independently from one another stand for (C₁-C₃)alkylene, preferably for C₁ or C₂ alkylene, more preferably for methylene or ethylene, and more preferably for methylene;
   wherein Q stands for C₆-arylene, preferably for 1,4-C₆-arylene, and more preferably for benzene-1,4-diyl;
   wherein R³ and R₄ independently from one another stand for (C₁-C₄)alkyl, preferably (C₁-C₃)alkyl, more preferably for methyl or ethyl, and more preferably for methyl; and
   wherein R₅, R₆, R₇, and R₈ independently from one another stand for (C₁-C₆)alkyl, preferably (C₁-C₅)alkyl, more preferably (C₁-C₄)alkyl, more preferably (C₁-C₃)alkyl, more preferably for ethyl, isopropyl, or n-propyl, and more preferably for ethyl or n-propyl.
2. The process of embodiment 1, wherein the one or more zeolitic materials in (1) display a framework structure type selected from the group consisting of MFI, MWW, MEL, BEA, CHA, MOR, and mixtures of two or more thereof, preferably from the group consisting of MFI, MWW, BEA, and mixtures of two or more thereof, wherein more preferably the one or more zeolitic materials in (1) display an MFI and/or MWW type framework structure.
3. The process of embodiment 1 or 2, wherein the tetravalent element Y is selected from the group consisting of Sn, Ti, Zr, and mixtures of two or more thereof, Y preferably being Sn and/or Ti, wherein Y is more preferably Ti.
4. The process of embodiment 3, wherein Y is Ti, and wherein the one or more zeolitic materials comprising SiO₂ and YO₂ in its framework structure comprises ZMQ-TB and/or TS-1, preferably TS-1, wherein preferably the one or more zeolitic materials comprising SiO₂ and YO₂ in its framework structure is ZMQ-TB and/or TS-1, preferably TS-1.
5. The process of embodiment 3 or 4, wherein Y is Ti, and wherein the zeolitic material having an IWR type framework structure is Ti-COE-6.
6. The process of any of embodiments 1 to 5, wherein the one or more sources of SiO₂ other than the one or more zeolitic materials is selected from the group consisting of silicates, fumed silica, silica hydrosols, reactive amorphous solid silicas, silica gel, silicic acid, colloidal silica, silicic acid esters, and mixtures of two or more thereof,
   preferably from the group consisting of silica hydrosols, silica gel, silicic acid, water glass, sodium metasilicate hydrate, sesquisilicate, disilicate, colloidal silica, tetra(C₁-C₄)alkylorthosilicate, and mixtures of two or more thereof,
   more preferably from the group consisting of silica hydrosols, silicic acid, tetra(C₂-C₃)alkylorthosilicate, and mixtures of two or more thereof,
   wherein more preferably the one or more sources for SiO₂ comprises tetraethylorthosilicate, wherein more preferably tetraethylorthosilicate is used as the one or more sources for SiO₂.
7. The process of any of embodiments 1 to 6, wherein the alkyl groups R₅ and R₆ are bound to one another to form one common alkylene chain, preferably a (C₅-C₇)alkylene chain, more preferably a (C₅-C₆)alkylene chain, more preferably a pentylene or hexylene chain, and more preferably a pentylene chain.
8. The process of any of embodiments 1 to 7, wherein the alkyl groups R₇ and R⁸ are bound to one another to form one common alkylene chain, preferably a (C₅-C₇)alkylene chain, more preferably a (C₅-C₆)alkylene chain, more preferably a pentylene or hexylene chain, and more preferably a pentylene chain.
9. The process of any one of embodiments 1 to 8, wherein the organodication of the formula (I) has the formula (II):

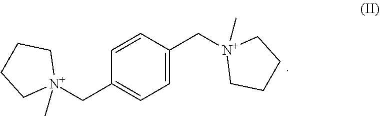 [SMILES: C[N+]1(Cc2ccc(C[N+]3(C)CCCC3)cc2)CCCC1]

10. The process of any one of embodiments 1 to 9, wherein the one or more organotemplates are provided as salts, preferably as one or more salts selected from the group consisting of halides, sulfate, nitrate, phosphate, acetate, hydroxide, and mixtures of two or more thereof, more preferably from the group consisting of bromide, chloride, hydroxide, sulfate, and mixtures of two or more thereof, wherein more preferably the one or more organotemplates are provided as hydroxides and/or bromides, and more preferably as hydroxides.
11. The process of any one of embodiments 1 to 10, wherein the mixture prepared in (1) further comprises seed crystals, wherein the seed crystals preferably comprise one or more zeolitic materials having an IWR type framework structure, preferably one or more all-silica zeolitic materials having an IWR type framework structure, wherein more preferably the seed crystals comprise all-silica ITQ-24, wherein more preferably one or more zeolitic materials having an IWR type framework structure is employed as the seed crystals, more preferably one or more all-silica zeolitic materials having an IWR type framework structure, wherein more preferably all-silica ITQ-24 is employed as the seed crystals.
12. The process of embodiment 11, wherein the amount of seed crystals comprised in the mixture prepared in (1) is in the range of from 0.1 to 25 wt.-% based on 100 wt.-% of the one or more sources of SiO₂ other than the one or more zeolitic materials calculated as SiO₂, and preferably from 0.5 to 20 wt.-%, more preferably from 1 to 18 wt.-%, more preferably from 3 to 15 wt.-%, more preferably from 5 to 12 wt.-%, and more preferably from 8 to 9 wt.-%.
13. The process of any one of embodiments 1 to 12, wherein the mixture prepared in (1) and heated in (2) contains less than 5 weight-% of Ge calculated as GeO₂ and based on 100 weight-% of the one or more sources of SiO₂ other than the one or more zeolitic materials calculated as SiO₂, preferably less than 3 weight-%, more preferably less than 1 weight-%, more preferably less than 0.5 weight-%, more preferably less than 0.1 weight-%, more preferably less than 0.05 weight-%, more preferably less than 0.01 weight-%, more preferably less than 0.005 weight-%, and more preferably less than 0.001 weight-%.
14. The process of any one of embodiments 1 to 13, wherein the mixture prepared in (1) and heated in (2) contains less than 0.5 weight-% of trivalent elements X calculated as the element and based on 100 weight-% of Si contained in the mixture, preferably less than 0.1 weight-%, more preferably less than 0.05 weight-%, more preferably less than 0.01 weight-%, more preferably less than 0.005 weight-%, and more preferably less than 0.001 weight-%.
15. The process of embodiment 14, wherein X is Al and/or B, wherein preferably X is Al and B, wherein more preferably X is Al, B, and Ga, and wherein more preferably X is Al, B, In, and Ga.
16. The process of any one of embodiments 1 to 15, wherein the mixture prepared in (1) and heated in (2) contains less than 5 wt.-% of P based on 100 wt.-% of Si contained in the mixture, preferably less than 3 weight-%, more preferably less than 1 weight-%, more preferably less than 0.5 weight-%, more preferably less than 0.1 weight-%, more preferably less than 0.05 weight-%, more preferably less than 0.01 weight-%, more preferably less than 0.005 weight-%, and more preferably less than 0.001 weight-%.
17. The process of any one of embodiments 1 to 16, wherein the one or more zeolitic materials comprising SiO₂ and YO₂ contained in the mixture prepared in (1) and heated in (2) displays an Si:Y atomic ratio Si to the tetravalent element Y in the range of from 5:1 to 500:1, preferably of from 10:1 to 250:1, more preferably of from 20:1 to 150:1, more preferably of from 25:1 to 100:1, more preferably of from 30:1 to 70:1, more preferably of from 32:1 to 50:1, more preferably of from 34:1 to 42:1, and more preferably of from 36:1 to 39:1.
18. The process of any one of embodiments 1 to 17, wherein the Si:Y atomic ratio of Si to the tetravalent element Y in the mixture prepared in (1) and heated in (2) is in the range of from 5 to 1,500, preferably of from 10 to 1,000, more preferably of from 20 to 600, more preferably of from 30 to 400, more preferably of from 40 to 250, more preferably of from 50 to 150, more preferably of from 60 to 100, and more preferably of from 70 to 80.
19. The process of any one of embodiments 1 to 18, wherein the organotemplate:Si molar ratio of the one or more organotemplates to Si in the mixture prepared in (1) and heated in (2) is in the range of from 0.01 to 1.5, preferably from 0.05 to 1.2, more preferably from 0.1 to 0.9, more preferably from 0.15 to 0.7, more preferably from 0.2 to 0.5, and more preferably from 0.25 to 0.3.
20. The process of any one of embodiments 1 to 19, wherein the mixture prepared in (1) further comprises one or more sources of fluoride, wherein preferably the F:Si atomic ratio in the mixture prepared in (1) and heated in (2) is in the range of from 0.01 to 2, preferably from 0.05 to 1.5, more preferably from 0.1 to 1, more preferably from 0.3 to 0.8, and more preferably from 0.5 to 0.6.
21. The process of embodiment 20, wherein the one or more sources of fluoride is selected from fluoride salts, HF, and mixtures of two or more thereof, preferably from the group consisting of alkali metal fluoride salts, HF, and mixtures of two or more thereof, wherein more preferably the one or more sources of fluoride comprise HF, wherein more preferably HF is employed as the one or more sources of fluoride.
22. The process of any one of embodiments 1 to 21, wherein heating in (2) is conducted for a duration in the range of from 10 min to 10 d, preferably from 30 min to 9 d, more preferably from 1 h to 8 d, more preferably from 2 h to 7 d, and more preferably from 3 h to 6 d, more preferably from 6 h to 5.5 d, more preferably from 0.5 to 5 d, more preferably from 1 d to 4.5 d, more preferably from 2 d to 4 d, and more preferably from 2.5 to 3.5 d.
23. The process of any one of embodiments 1 to 22, wherein heating in (2) is conducted at a temperature in the range of from 80 to 220° C., preferably of from 110 to 200° C., more preferably of from 130 to 190° C., more preferably of from 140 to 180° C., more preferably of from 150 to 170° C., and more preferably of from 155 to 165° C.
24. The process of any one of embodiments 1 to 23, wherein heating in (2) is conducted under autogenous pressure, preferably under solvothermal conditions, more preferably under hydrothermal conditions, wherein preferably heating in (2) is performed in a pressure tight vessel, preferably in an autoclave.
25. The process of any one of embodiments 1 to 24, wherein the process further comprises
   (3) isolating the zeolitic material obtained in (2),
   and/or
   (4) washing the zeolitic material obtained in (2) or (3),
   and/or
   (5) calcining the zeolitic material obtained in (2), (3), or (4),
   wherein the steps (3) and/or (4) and/or (5) can be conducted in any order, and
   wherein one or more of said steps is preferably repeated one or more times.
26. The process of embodiment 25, wherein calcination in (5) is conducted for a duration in the range of from 0.5 to 15 h, preferably of from 1 to 10 h, more preferably of from 2 to 8 h, more preferably of from 3 to 7 h, more preferably of from 3.5 to 6.5 h, more preferably of from 4 to 6 h, and more preferably of from 4.5 to 5.5 h.
27. The process of embodiment 25 or 26, wherein calcination in (5) is conducted at a temperature in the range of from 300 to 800° C., preferably of from 350 to 700° C., more preferably of from 400 to 650° C., more preferably of from 450 to 600° C., and more preferably of from 500 to 550° C.
28. The process of any one of embodiments 1 to 27, wherein the solvent system is selected from the group consisting of optionally branched (C₁-C₄) alcohols, distilled water, and mixtures thereof, preferably from the group consisting of optionally branched (C₁-C₃) alcohols, distilled water, and mixtures thereof, more preferably from the group consisting of methanol, ethanol, distilled water, and mixtures thereof, wherein more preferably the solvent system comprises distilled water, wherein more preferably the solvent system consists of distilled water.
29. The process of embodiment 28, wherein the H₂O:YO₂ molar ratio of H₂O to the one or more sources of SiO₂ other than the one or more zeolitic materials, calculated as SiO₂, in the mixture prepared in (1) and heated in (2) is in the range of from 0.5 to 15, preferably from 1 to 10, more preferably from 1.5 to 5, and more preferably from 2 to 3.
   30. A zeolitic material having an IWR type framework structure obtainable and/or obtained from the process of any one of embodiments 1 to 29.
   31. The zeolitic material of embodiment 30, wherein the zeolitic material having an IWR type framework structure is Ti-COE-6.
   32. Use of a zeolitic material according to embodiment 30 or 31 as a molecular sieve, as an adsorbent, for ion-exchange, or as a catalyst and/or as a catalyst support, wherein the zeolitic material is preferably used as a catalyst in a reaction involving C—C bond formation and/or conversion, and preferably as a catalyst in an isomerization reaction, in an amoximation reaction, in an amination reaction, in a hydrocracking reaction, in an alkylation reaction, in an acylation reaction, in a reaction for the conversion of alkanes to olefins, or in a reaction for the conversion of one or more oxygenates to olefins and/or aromatics, in a reaction for the synthesis of hydrogen peroxide, in an aldol condensation reaction, in a reaction for the isomerization of epoxides, in a transesterification reaction, in a hydroxylation reaction, in a Baeyer-Villiger-type oxidation reaction, in a Dakin-type reaction, in the synthesis of isoprenol, in a Prins condensation reaction, or in an epoxidation reaction, preferably as a catalyst in a hydroxylation reaction, in a Baeyer-Villiger-type oxidation reaction, in a Dakin-type reaction, in a Prins condensation reaction, or in a reaction for the epoxidation of olefins, more preferably in a reaction for the epoxidation of olefins, more preferably in a reaction for the epoxidation of C2-C5 alkenes, more preferably in a reaction for the epoxidation of C2-C4 alkenes, in a reaction for the epoxidation of C2 or C3 alkenes, more preferably for the epoxidation of C3 alkenes, and more preferably as a catalyst for the conversion of propylene to propylene oxide.
   33. The use of embodiments 32, wherein the zeolitic material is used as a catalyst for the activation of hydrogen peroxide.

### DESCRIPTION OF THE FIGURES

FIG. 1 displays the XRD pattern of the TS-1 obtained according to Comparative Example 1.

FIG. 2 displays the XRD pattern of the crystalline material obtained according to Comparative Example 1.

FIG. 3 displays the SEM images of the crystalline material obtained according to Comparative Example 1.

FIG. 4 displays the XRD pattern of the Ti-COE-6 obtained according to Example 1.

FIG. 5 displays the SEM images of the Ti-COE-6 obtained according to Example 1.

### EXPERIMENTAL SECTION

### Characterization Via X-Ray Diffraction Analysis

X-ray powder diffraction (XRD) patterns were measured with a Rigaku Ultimate VI X-ray diffractometer (40 kV, 40 mA) using CuKα (λ1.5406 Å) radiation.

### Characterization Via SEM and TEM

Scanning electron microscopy (SEM) experiments were performed on Hitachi SU-1510 electron microscopes. Transmission electron microscopy (TEM) experiments were conducted on a JEOL JEM-2100P at 200 kV.

### K-80 Test

### Experimental Procedure

In a clean 100 ml flask with a magnetic stirring bar and a thermometer were placed 24 g of deionised water and 5.2 g of a 40 weight-% hydrogen peroxide solution at room temperature. At this point a t=0 probe of ca. 0.3 ml is taken with a pipette. The flask is lightly stoppered and then immersed in a previously equilibrated thermostating bath set to 80° C. To obtain reproducible results it is important to use always the same amount of catalyst and to control the temperature to better than ±1° C. during the experiment. As soon as the hydrogen peroxide solution is in thermal equilibrium with the thermostating bath, 400 mg (±1 mg) of the catalyst (either powder or extrudates) are added. The suspension is stirred and samples of the supernatant liquid are then taken at regular intervals. The probe should be taken with a 1 ml syringe with a one-way filter Millipore Millex-HV SLHV 013 NL (order number 4875 160) or equivalent. First 0.6 ml of solution are sucked into the syringe through the filter. Then 0.3 ml of the solution are backflushed through the filter in to the flask. This is necessary in order to minimise loss of catalyst. The remaining 0.3 ml in the syringe are then used for the peroxide determination. The interval between probes is usually between 30 and 60 min depending on the catalyst activity.

The experiment is finished after 7 hours.

### Analytics

The probes are analysed for H₂O₂ content by using a standard cerimetric titration. It is advisable to analyse the probes as soon as possible after they are collected. In order to ensure a good precision the amount of titrating solution used should be at least 5 ml. If necessary a larger amount of probe has to be weighed in.

### Data Analysis

The natural logarithm of the H₂O₂ concentration is plotted against time. It is important to always use the same units when comparing data (for instance H₂O₂ concentration in weight-% and time in hours). This plot usually gives a good straight line. Using least squares methods the slope is extracted. This slope is the pseudo-first order decay rate of H₂O₂ in the presence of the catalyst (in h⁻¹) and is called the k80 value.

### Materials for Synthesis

p-xylylene dibromide (C₈H₈Br₂, 97%, Aladdin Chemistry Co., Ltd.), tetraethylorthosilicate (C₈H₂₀O₄Si, TEOS, 99%, Aladdin Chemistry Co., Ltd.), hydrofluoric acid (HF, AR, 40%, Aladdin Chemistry Co., Ltd.), 1-methylpyrrolidine (C₅H₁₁N, 98%, Aladdin Chemistry Co., Ltd.), acetonitrile (C₂H₃N, AR, 99%, Sinopharm Chemical Reagent Co., Ltd.), titanium butoxide (C₁₆H₃₆O₄Ti, 99%, Aladdin Chemistry Co., Ltd.).

### Reference Example 1: Synthesis of TS-1

For the gel preparation, 500 g tetraethylorthosilicate (TEOS) and 15 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.83. The mixture was hydrolyzed at room temperature for 60 min during which the temperature rose to 60° C. The mixture had a pH of 12.71 then. Afterwards the ethanol was distilled off until the sump reached a temperature of 95° C. 558 g of distillate was obtained from distillation.

The synthesis gel was then cooled to 40° C. under stirring and 558 g de-ionized water added thereto. The resulting mixture had a pH of 11.95.

The synthesis gel was then transferred into an autoclave. The synthesis gel was heated under stirring in the autoclave to a temperature of 175° C. and stirred at said temperature for 16 h under autogenous pressure. The pressure was in the range of from 8.4 to 11.4 bar (abs). The resulting suspension was then worked-up. To this effect, the resulting suspension was diluted with de-ionized water, wherein the weight ratio of the suspension to de-ionized water was 1:1. Then, about 152 g nitric acid (10 weight-% in water) were added and the resulting mixture had a pH of 7.21. The obtained solids were filtered off and washed three times with de-ionized water (each time 1000 ml de-ionized water were used). Subsequently, the solids were dried in an oven in air at 120° C. for 4 h and then calcined in air at 490° C. for 5 h, wherein the heating rate for calcining was 2° C./min.

The resulting TS-1 material had a Si content of 43 weight-%, a Ti content of 2 weight-%, and a total loss of carbon of less than 0.1 weight-%. The BET specific surface area of the resulting TS-1 material was 447 m²/g. The crystallinity was 92%, and about 0.5% of anatase were detectable by X-ray diffraction.

Then, 382.0 g deionized water were provided in a beaker. 150.9 g tetrapropylammonium hydroxide (as an aqueous solution comprising 40 weight-% tetrapropylammonium hydroxide) were added under stirring. Subsequently, 71.0 g of the TS-1 material were added. This mixture was homogenized for 30 min. The mixture was then transferred into an autoclave. The mixture was hydrothermally treated at 170° C. for 6 hours. The resulting solids were separated via centrifugation, and the solid residue obtained was washed with deionized water. The resulting solid was dried in air at 120° C. for 4 h and calcined in air at 490° C. for 5 h in an oven.

The resulting TS-1 product had a Si content of 44 weight-%, a Ti content of 1.9 weight-%, and a total loss of carbon of less than 0.1 weight-%. The BET specific surface area of the resulting TS-1 product was 446 m²/g, and the water adsorption 7.25 wt.-%. The crystallinity was 93%, and about 0.7% of anatase were detectable by X-ray diffraction.

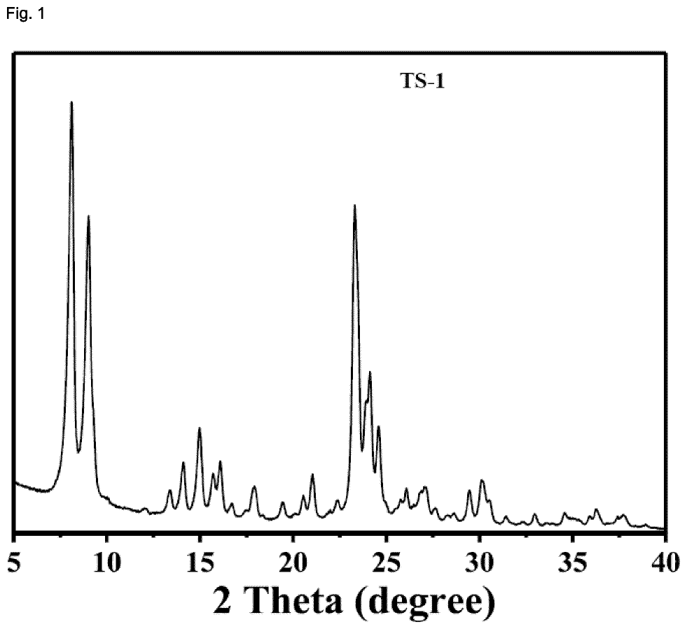

In FIG. 1, the XRD pattern of the TS-1 material is displayed.

### Reference Example 2: Synthesis of p-xylylene-bis((N-methyl)N-pyrrolidinium) hydroxide

In a typical example for the synthesis of the organotemplate, 13.2 g p-xylylene dibromide was dissolved in 250 mL acetonitrile, then 10.6 g 1-methylpyrrolidine was added, stirring for 48 h under reflux. After cooling to the room temperature, the mixture was filtrated and washed with acetonitrile three times. The solid was dried under vacuum condition overnight. The bromide cation was converted to hydroxide form using hydroxide exchange resin in water, and the obtained solution was titrated using 0.1 M HCl as titration.

### Comparative Example 1: Synthesis of a Titanium-Zeolite Having an IWR Type Framework Structure

0.5 g of TS-1 obtained according to Reference Example 1 was added into a solution of pxylylene-bis((N-methyl)N-pyrrolidinium) hydroxide (4.25 g, 0.98 mmol/g), as obtained from Reference Example 2, in a 25 ml beaker. After stirring for 2 h, 0.36 mL of hydrofluoric acid (40% aqueous solution) was added to the above solution, the beaker was put into an oven with a temperature of 80° C. to evaporate excess water. Lastly, 0.03 g of pure silica IWR seeds (seeds were synthesized using the same organotemplate) was added to the above mixture, and then the mixture was ground. The final molar composition of the mixture was 1.0 SiO₂:0.5 OSDA:0.0263 TiO₂:1 HF:2H₂O. After grinding, the powder was transferred into a Teflon lined autoclave and sealed, crystallizing at 160° C. for 72 h under rotation conditions (50 rpm).

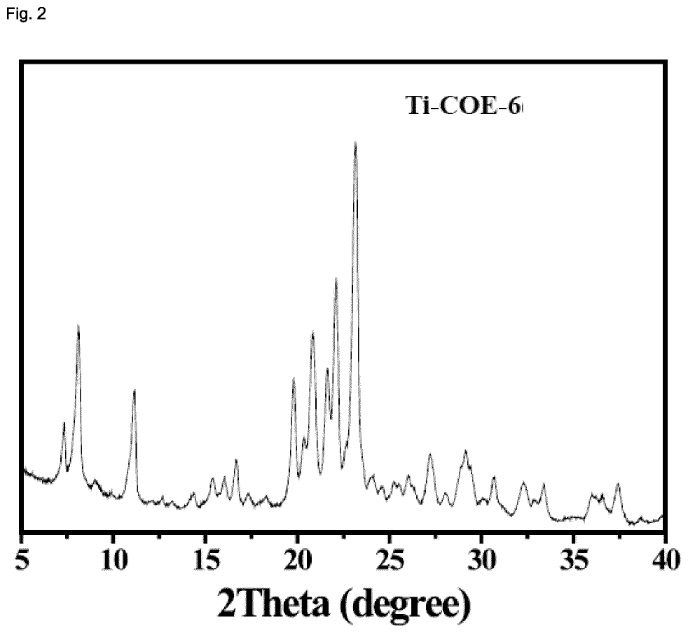

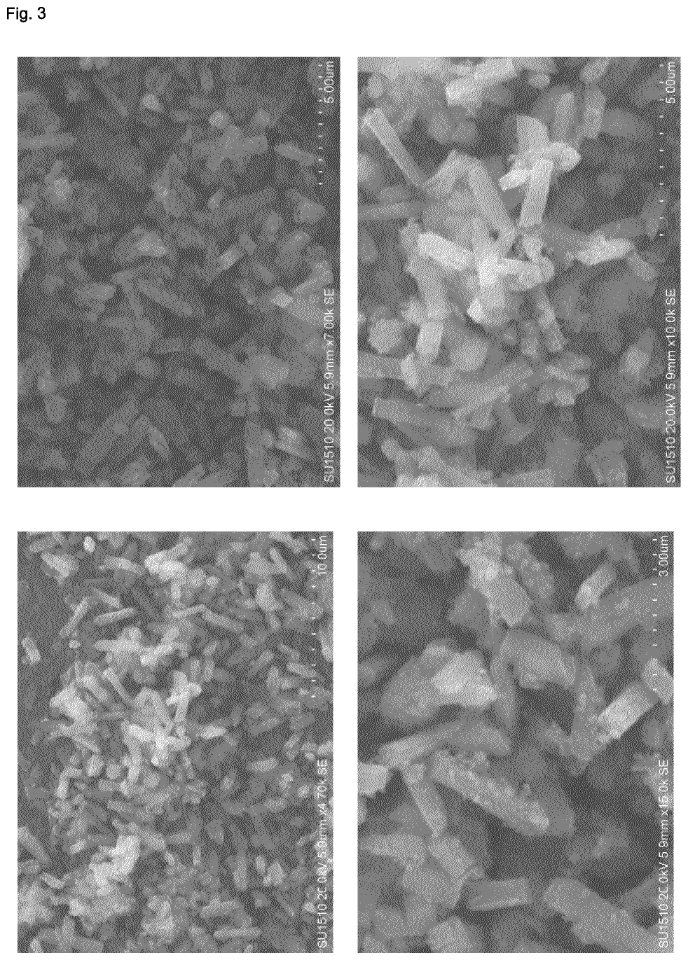

In FIG. 2, the XRD pattern of the crystalline material is displayed. In FIG. 3, TEM images of the crystalline material is displayed.

As may be taken from the XRD pattern in FIG. 2, small amounts of TS-1 are still present in the final product.

### Example 1: Synthesis of a High Purity Titanium-Zeolite Having an IWR Type Framework Structure (Ti-COE-6)

0.25 g of TS-1 obtained according to Reference Example 1 was added into a solution of pxylylene-bis((N-methyl)N-pyrrolidinium) hydroxide (3.375 g, 0.75 mmol/g), as obtained from Reference Example 2, in a 25 ml beaker, and then 1.274 g of tetraethyl orthosilicate (TEOS) was added to this mixture. After stirring for 12 h, 0.22 mL of hydrofluoric acid (40% aqueous solution) was added to the above solution, the beaker was put into an oven with a temperature of 80° C. to evaporate excess water and ethanol. Lastly, 0.03 g of pure silica IWR seeds (seeds were synthesized using the same organotemplate) was added to the above mixture, and then the mixture was ground. The final molar composition of the mixture was 1.0 SiO₂:0.25 OSDA:0.0133TiO₂:0.5 HF:2H₂O. After grinding, the powder was transferred into a Teflon lined autoclave and sealed, crystallizing at 160° C. for 72 h under rotation conditions (50 rpm).

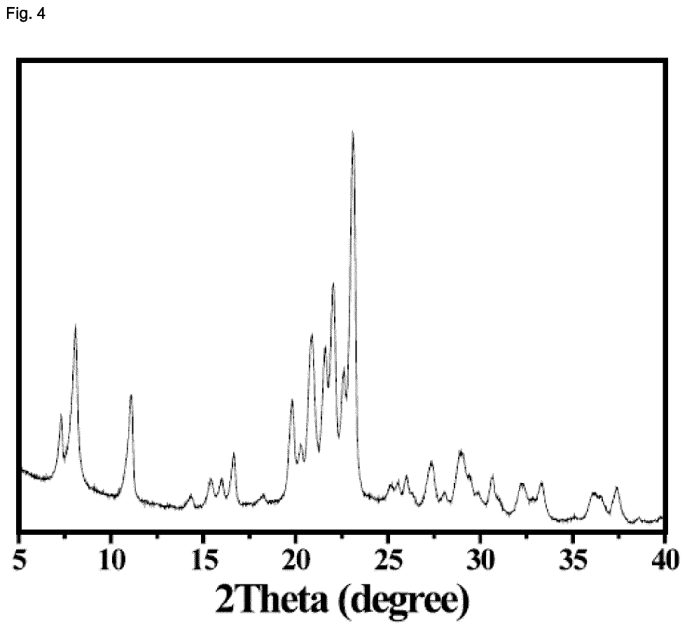

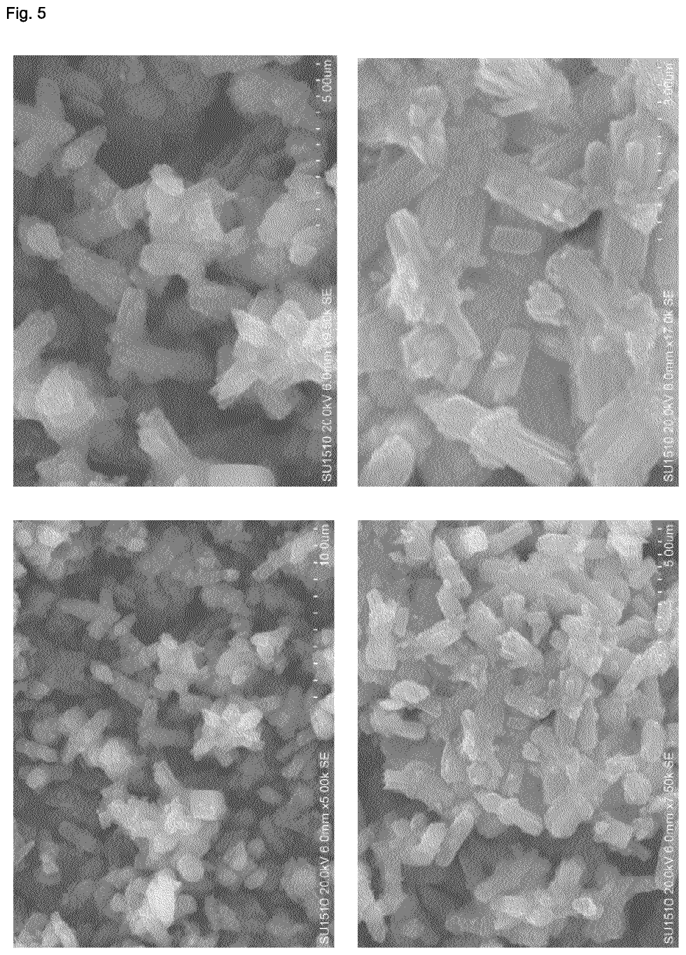

In FIG. 4, the XRD pattern of the Ti-COE-6 material is displayed. In FIG. 5, TEM images of the Ti-COE-6 material is displayed.

As may be taken from the XRD pattern in FIG. 4, compared to the XRD pattern of the crystalline material from Comparative Example 1 (see FIG. 2), the TI-COE-6 material obtained according to Example 1 is of a very high purity, wherein no traces of the TS-1 starting material may be found in the diffraction pattern. Furthermore, as may be taken from the TEM images displayed in FIG. 5, compared to the TEM images of the crystalline material from Comparative Example 1 (see FIG. 3), the crystals of the Ti-COE-6 material obtained according to Example 1 are considerably larger.

The K-80 test applied to the Ti-COE-6 material obtained according to Example 1 afforded a K80 value of 0.0617 h⁻¹.

Accordingly, it has surprisingly been found that by employing the inventive method, Ti-COE-6 of a very high purity and furthermore displaying large sizes of the primary crystallites may be obtained. Furthermore, as may be taken from the result from the K-80 test, the Ti-COE-6 material is able to activate hydrogen peroxide.

### CITED PRIOR ART

EP 1 609 758 B1
Cantin, A. et al. in J. Am. Chem. Soc. 2006, 128, pp. 4216-4217
Shamzhy, M. et al. in Catal. Today 2015, 243, 76-84
WO 2020/244630 A
Hong, X. et al. in J. Am. Chem. Soc. 2019, 141, 45, 18318-18324
CN 111847474 A
U.S. Pat. No. 7,344,696 B2

1.-15. (canceled)

16. A process for the preparation of a zeolitic material having an IWR type framework structure, wherein the IWR type framework structure is Ti-COE-6, wherein the process comprises
(1) preparing a mixture comprising one or more organotemplates as structure directing agents, one or more zeolitic materials comprising SiO₂ and YO₂ in its framework structure, one or more sources of SiO₂ other than the one or more zeolitic materials, seed crystals, one or more sources of fluoride selected from fluoride salts, HF, and mixtures of two or more thereof, and a solvent system;
wherein Y is Ti, and wherein the one or more zeolitic materials comprising SiO₂ and YO₂ in its framework structure comprises ZMQ-TB and/or TS-1,
wherein the one or more sources of SiO₂ other than the one or more zeolitic materials is selected from the group consisting of silicates, fumed silica, silica hydrosols, reactive amorphous solid silicas, silica gel, silicic acid, colloidal silica, silicic acid esters, and mixtures of two or more thereof,
wherein the seed crystals comprise one or more all-silica zeolitic materials having an IWR type framework structure,
(2) heating the mixture obtained in (1) for crystallizing a zeolitic material having an IWR type framework structure comprising SiO₂ and YO₂ in its framework structure;
wherein the one or more organotemplates comprise an organodication of the formula (II):

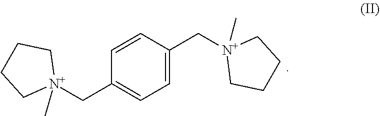 [SMILES: C[N+]1(Cc2ccc(C[N+]3(C)CCCC3)cc2)CCCC1]

17. The process of claim 16, wherein the mixture prepared in (1) and heated in (2) contains less than 5 weight-% of Ge calculated as GeO₂ and based on 100 weight-% of the one or more sources of SiO₂ other than the one or more zeolitic materials calculated as SiO₂.

18. The process of claim 16, wherein the mixture prepared in (1) and heated in (2) contains less than 0.5 weight-% of trivalent elements X calculated as the element and based on 100 weight-% of Si contained in the mixture.

19. The process of claim 18, wherein X is Al and/or B.

20. The process of claim 16, wherein heating in (2) is conducted at a temperature in the range of from 80 to 220° C.

21. A zeolitic material having an IWR type framework structure obtainable and/or obtained from the process of claim 16, wherein the IWR type framework structure is Ti-COE-6.

22. A molecular sieve, adsorbent, catalyst or catalyst support comprising the zeolitic material according to claim 21.
